(19) United States
(12) Patent Application Publication
(10) Pub. No.: US 2012/0191446 A1
(43) Pub. Date: Jul. 26, 2012

(54) System and method for creating a parser generator and associated computer program

(75) Inventors: Henri Binsztok, Paris (FR); Adam Koprowski, Amsterdam (NL)

(73) Assignee: PROVICIEL - MLSTATE, Paris (FR)

(21) Appl. No.: 13/384,326

(22) PCT Filed: Jul. 15, 2009
(86) PCT No.: PCT/EP2009/059115

§ 371 Date: Apr. 2, 2012

(51) Int. Cl. G06F 17/27

(52) U.S. Cl. 704/9

(57) ABSTRACT

A system is provided for building a parser generator. The system includes a grammar input module for inputting in the parser generator a grammar expressed in a given formalism. A checking module formally verifies that a given grammar belongs to a predetermined class of grammars for which a translation to a correct, terminating parser is feasible. A checking module formally verifies that a grammar expressed in the formalism is well-formed. A semantic action module defines a parsing result depending on semantic actions embedded in the grammar. The semantic action module ensures in a formal way that all semantic actions of the grammar are terminating semantic actions. A formal module generates a parser with total correctness guarantees, using the modules to verify that the grammar is well-formed, belongs to a certain class of feasible, terminating grammars and all its semantic actions are terminating.

### CROSS-REFERENCE TO RELATED APPLICATIONS

This Application is a Section 371 National Stage Application of International Application No. PCT/EP2009/059115, filed Jul. 15, 2009, which is incorporated by reference in its entirety and published as WO 2011/015222 on Feb. 10, 2011, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates to the parsing problem in computer science and electronics. More specifically, the disclosure relates to methods of generating formally-verified parsers from simple grammar description files.

Parsing consists of taking a text, recognizing whether it is correct with respect to the description of the language used to write the text, given by means of a grammar and, if it is, pulling it apart with respect to the structure of the given grammar.

Parsing is used extensively in a variety of computer science and electronics field including compilation, network security, data storage, etc.

As a first example, during compilation, a source code is first parsed then compiled and assembled into an executable. Bugs and anomalies in executables can result in important loss of time, money, data and sometimes lives. Extensive testing is not considered sufficient in critical applications. A second example is dedicated to network security. A message arriving at a network node is parsed and depending on the results of said parsing it is either transmitted or blocked. Said network node in effect works as a kind of “digital diode”. XML signatures and XML encryption are growingly used to secure transactions, in particular across mobile networks.

A third example applies to data. Stored content is parsed in order to retrieve data of interest. Database queries expressed in query language e.g. SQL also need to be parsed before data are accessed.

A fourth example is dedicated to data interpretation. Each web page code is parsed in order to be displayed in a web browser.

A fifth example highlights on Domain Specific Languages (DSL). DSL are programming or specification languages dedicated to a particular solution technique e.g. insurance, finance, construction, combat simulation. Every time a new DSL is created to simplify programming in a given technical field, a new parser needs to be created at the same time.

Other applications of parsers exist and are not detailed here (cryptography, compression, . . . ).

### BACKGROUND OF THE DISCLOSURE

The parsing process is usually broken up into two steps:
A lexical analysis where the input text is decomposed into individual tokens; and
A syntax analysis where the sequence of tokens is analysed and the parse tree is build, representing the structural decomposition of the input text with respect to the grammar.
Parsing is a crucial step in any interpreter/compiler, where the source code of the program needs to be parsed before being interpreted/transformed into the target language. But it is also an important step in many other programs performing any kind of data manipulation.
Parsing technology is a well-studied and well-understood problem in computer science or electronics component design. The typical approach to parsing is to specify the input language using context-free grammars and to use a parser generator. Parser generators are programs that:
take a description of a (context-free) grammar [symbol] from a file (in some format).
if grammar [symbol] belongs to some sub-class of context-free grammars supported by the parser generator, then it automatically constructs a source code for a parser of [symbol] , in some programming language of choice, [symbol] .
the resulting parser of [symbol] can then be used in another program.

Indeed, parsers are usually used within some programs and rarely on their own; the source code obtained in the previous step allows to easily use the generated parser for [symbol] within some program written in [symbol] .

In formal language theory, a context-free grammar (CFG) is a grammar in which every production rule is of the form:

V→w

where V is a single nonterminal symbol, and w is a string of terminals and/or nonterminals (possibly empty).

The problem of these background techniques is that the formal check of the parser is not formally proven, i.e. it can't be proved that the generated parser will work correctly. Thus, it's not possible to prove that the parser obtained by prior art techniques is correct and will not lead to misinterpret the data in input (A program written by a programmer) and consequently will not lead to error in parsing, compiling or executing some resulting programs.

### SUMMARY

An embodiment of the invention concerns a system for creating a parser. The system for building a parser comprises:
a grammar input module for inputting in said parser a grammar expressed in a given formalism;
a formalism module for expressing grammars used by said parser generator, said formalism module proving that said grammar G is well-formed;
a semantic action module defining a parsing result depending on at least some expression of said grammar, said semantic action module ensuring that all semantic actions of said grammar are terminating
a checking module for checking that a given grammar belongs to a predetermined class of grammars for which a translation to a correct, terminating parser is feasible; and, if checking module concludes that said grammar belongs to said
a proof assistant module for developing said parser with said formalism module and said semantic action module.

Thus, in the previous fields of technologies already presented, fields, employing parsers constructed using the system of an embodiment of the invention results in better quality thanks to increased security. Security issues in software and electronic components do clearly lead to technical problems that affect the physical world. Formal proof methods can be used to check the conformity of a program with the specifications. Certified compilers have also been described see e.g. Compcert (Xavier Leroy) but the correction of the first step, parsing, is not formally proven.

Having a proven parser is therefore essential for network security. Parsing is also an important first step in security software's such as firewalls or antivirus.

Having a proven parser brings guarantees on the ability to retrieve data and the quality of the parser of an embodiment of the invention impacts on that of the displayed page.

According to one particular characteristic of an embodiment of the invention, said a formalism module forbids recursion in said grammar.

According to one particular characteristic of an embodiment of the invention said grammar is a context-free grammar;

According to one particular characteristic of an embodiment of the invention said grammar is a parsing expression grammar;

An embodiment of the invention also concerns a method for building a formally verified parser generator.

According to an embodiment of the invention, said method comprises:
A step of formalizing an expression of a grammar G and its semantics;
A step of checking that said grammar G belongs to a predetermined class of grammars for which a translation to a correct, terminating parser is feasible;
A step of defining a target language Q of said parser generator and its formal semantics; A step of obtaining a library of basic datatypes of Q and functions over them and proving that they are all terminating;
A step of obtaining a formally correct parser for Q;
A step of obtaining a formally correct parser for a grammar in FPG format, said including semantic actions in Q;
A step of obtaining a termination checker for semantic actions in Q;
A step of obtaining a parser generator, that will read a description of some grammar G from a text file using said certified parser and, after checking that the grammar belongs to a class for which parser generation is feasible, it will generate a code of the parser in Q.
A step of obtaining, from a proving module, that the code generated in is correct with respect to the given grammar G, the semantics of parsing grammars and the formal semantics of Q.
A step of obtaining, from a proving module, that the code generated in will always terminate.

Another embodiment of the invention concerns a computer program product downloadable from a communications network and/or stored on a computer-readable medium and/or executable by a microprocessor.

According to another embodiment of the invention, such a computer program product comprises program code instructions for the execution of the building method as described.

### BRIEF DESCRIPTION OF THE DRAWINGS

Other features and advantages shall appear more clearly from the following description of a preferred embodiment, given by way of a simple, illustrative and non-exhaustive example, and from the appended drawings, of which:

FIG. 1 is a block diagram illustrating the building blocks of a certified parser interpreter of an embodiment of the invention;

FIG. 2 is a block diagram illustrating the Building blocks of a certified parser generator in one embodiment of the invention.

### DETAILED DESCRIPTION OF ILLUSTRATIVE EMBODIMENTS

### 1. Generals Principles of An Embodiment of the Invention

An embodiment of the invention relates to a system for building a parser. According to an embodiment of the invention, such a system comprises of:—a grammar input module for inputting in said parser generator a grammar expressed in a given formalism;—a checking module for formally verifying that a given grammar belongs to a predetermined class of grammars for which a translation to a correct, terminating parser is feasible;—a checking module for formally verifying that a grammar expressed in the said formalism is well-formed;—a semantic action module defining a parsing result depending on semantic actions embedded in said grammar, said semantic action module ensuring in a formal way that all semantic actions of said grammar are terminating and—a formal module generating a parser with total correctness guarantees, using said modules to verify that the grammar is well-formed, belongs to a certain class of feasible, terminating grammars and all its semantic actions are terminating.

The system and method of an embodiment of the invention allows a user to build a parser generator which generates some parsers which are formally checked and verified. This means that, by using an embodiment of the invention, there's no need to formally verify a generated parser like in the prior art techniques. This is a great feature of an embodiment of the invention because it ensures that, when effectively used, the parser will always lead to a formally checked and verified program (after compilation).

Such a result is achieved, in at least one embodiment of the invention, firstly by extending the grammar with semantic action, as shown above and secondly by proving the termination of the grammar, and in particular addressing the problems of left-recursive grammar. Then these rules are introduced in a Proof Assistant (PA) to develop a formally verified parser interpreter/generator.

The proves of the theorems and lemma which are presented below aims at showing that the realization of embodiments are technically possible if the input grammar follows some requirements fixed.

For the purposes of proves below, an embodiment of the invention is using, in at least one embodiments, some Parsing Expression Grammars (PEGS). A parsing expression grammar, or PEG, is a type of analytic formal grammar that describes a formal language in terms of a set of rules for recognizing strings in the language. A parsing expression grammar essentially represents a recursive descent parser in a pure schematic form that expresses only syntax and is independent of the way an actual parser might be implemented or what it might be used for. Parsing expression grammars look similar to regular expressions or context-free grammars (CFG) in Backus-Naur form (BNF) notation, but have a different interpretation.

Unlike CFGs, PEGs cannot be ambiguous; if a string parses, it has exactly one valid parse tree, so PEGs are particularly well adapted for computer program languages.

The parser generator of an embodiment of the invention, instead of context-free grammars is based on the formalism of parsing expression grammars (PEGs). Below we shortly summarize this formalism for the purposes of the disclosure.

Let fix a finite set of non-terminals, [symbol] _{N} (sometimes we will also refer to them as productions), and a finite set of terminal symbols V_{T}. We will denote the elements of [symbol] _{N} by p,q and elements of V_{T} by x,y.

By string, S, we mean a list of terminal symbols and we will be using a list notation where x::xs denotes an element x followed by a list xs and [ ] denotes an empty list. We will use a notation |x| to denote length of string/list x.

Definition 1: Let define the set of parsing expressions, Δ, over non-terminals [symbol] _{N} and terminals V_{T}, as:

D:=[epsilon]|[x]|V_{T}|V_{N}|D,D|D/D||!D

More formally the set Δ is defined inductively as follow:
Δ:=ε empty expression
         |[•]• any character
         |a a terminal symbol (a∈υ_{T})
         |A a non-terminal (A∈υ_{N})
         |e₁; e₂ a sequence (e₁,e₂∈Δ)
         |e₁/e₂ a prioritized choice (e₁,e₂ ∈Δ)
         |e* a zero-or-more repetition (e∈Δ)
         |!e a not-predicate (e∈Δ)

Definition 2: A parsing expressions grammar (PEG), [symbol] is a quadruple (υ_{N}, υ_{T}, Pₑₓₚ, eₛ), where:
V_{T}. is a finite set of terminals,
[symbol] _{N} is a finite set of non-terminals of the grammar,
Pₑₓₚ is the interpretation of the productions of the grammar, i.e., Pₑₓₚ [symbol] _{N}→Δ and
eₛ is the start production of the grammar, eₛε [symbol] _{N}

The informal semantics of parsing expressions is as follows:
The empty expression [∈] always succeeds without consuming any input.
The any-character expression [•] consumes arbitrary character and succeeds; it fails on empty input.
A terminal a checks the first character of the input string; if it is equal to a then it is consumed and parsing succeeds, if it is different than a or the input string is empty then parsing fails.
Parsing of a non-terminal A amounts to parsing the expression associated with A, i.e., Pₑₓₚ(A).
Parsing the sequence expression e₁;e₂ amounts to parsing e₁ on the input string. If that fails then parsing of e₁;e₂ fails; otherwise it is the result of parsing e₂ on the remaining input.
Parsing the choice expression e₁/e₂ first parses e₁ on the input string and if that succeeds then this is the final result. Otherwise it is the result of parsing e₂ on the initial input string.
Parsing the zero-or-more repetition expression e* tries to parse e; if that fails then parsing of e* succeeds without consuming any input; if it succeeds then we proceed with parsing e* on the remaining input.
Parsing the non-predicate expression !e parses e on the input string; if that fails then !e succeeds without consuming any input; otherwise !e fails.

The formal description is as follows. The parsing of an expression e∈Δ on a string s∈S yields a result r∈ [symbol] denoted by (e, s) [symbol] r, where the set of results [symbol] is a set defined inductively as:
⊥ indicating that parsing failed,
√ₛ, for s∈S, indicating that parsing was successful and the suffix that remains to be parsed is s.

The formal semantics of parsing expressions is presented in annex A, which is fully included in the present disclosure.

As an example let us present a very simple grammar for mathematical expressions with 5 non-terminals and the following productions:
digit:=0/1/2/3/4/5/6/7/8/9
term:=digit+/[(]expr[)]
factor:=term[*]factor/term
expr:=factor[+]exp/factor
input:=expr

### Example 1

As an example let us present a very simple grammar for mathematical expressions with 5 non-terminals and the following productions:

ws::([ [symbol] ]/[\t])*

number::=[0-9]30

term::=ws number ws/ws [(]expr[)]ws

factor::=term[*]factor/term

expr::=factor[+]expr/factor

Here has been described the formalism of PEG which is used as an input grammar in at least one embodiment of the invention. While such this formalism is not one part of the invention, it is important for the disclosure because it helps the skilled in the art to understand the following work which has been

### 2. Description of Some Embodiments

In the present section a system/method for creating a parser generator of an embodiment of the invention is presented. Firstly a way to extend PEGs with semantics action is presented and secondly the demonstration for the termination of PEG is given on the basis of some hypothesis, then the use of such a grammar (extended and proved) is shown in an interpreter and in a parser generator.

### 2.1 Extending PEGs With Semantics Actions

The parsing expressions, as introduced previously can be used for specifying which strings belong to the grammar under consideration. However the role of a parser is not merely to recognize whether an input is correct or not but also, given a correct input, to compute its representation in one form or another.

This is typically done by extending grammar expressions with semantic values, which are a representation of the result of parsing this expression on (some) input and by extending grammar with semantic actions, which are functions used to produce and manipulate the semantic values.

Typically a semantic value associated with an expression will be its parse tree so that parsing a correct input will give a parse tree of this input. In order to deal with this extension the inventors had the idea to replace the simple type of parsing expressions Δ with a family of types Δ_{α}, where the index α is the type of semantic values associated with an expression.

The inventors also define default semantic actions for all types of expressions and to allow alerting from those default they introduced a new construction to convert semantic value.

The inventors use the following types:
Type is a universe of types.
True is the singleton type with a single value I.
char is a type of machine characters. It corresponds to the type of terminals [symbol] , which in concrete parsers generated will always be instantiated by char.
list α is a type of lists of elements of α for any type α,
α*β is a type of pairs of elements (a,b) with a∈α, b∈β for any types α,β.

Now it is shortly describe how the inventors extend the parsing expressions from definition 1 to incorporate semantic values.
An empty expression ε has a semantic value of type I.
Any character expression [•] and a terminal expression a (a∈ [symbol] _{N}) both have a semantic value of type char.
For non-terminals the inventors use a function P_{type}: [symbol] _{N}→Type which gives types of semantic values of all productions.
A sequence e₁;e₂ has semantic values of type α*β where α (resp. β) is the type of semantic values of e₁ (resp. e₂).
A prioritized choice e₁/e₂ has a semantic values of type a where semantic values of both e₁ and e₂ are required to have type α.
A repetition expression e* has a semantic value of type list α, where α is the type of semantic values of e.
A not-predicate has a semantic value of type I.
The inventors add a new expression e[ [symbol] ]ƒ which takes an expression e with semantic values of type α and a function ƒ:α→β and gives an expression with semantic values of type β (obtained by applying ƒ to the semantic value of e).

This leads to the following formal definition.

Definition 3: Δ_{α} is the set of extended parsing expressions, where the index α is the type of semantic values of an expression. We define it by induction in Annex B, where:
T is the set of terminals,
[symbol] _{N} is the set of non-terminals,
and PT: [symbol] _{N}→Type is the function giving type of semantic values for every non-terminal.

The definition of an extended parsing expression grammar (EPEG) is as expected (compare with Definition 2):

Definition 4: An extended parsing expressions grammar (EPEG), [symbol] is a tuple (υ_{N}, υ_{T}, P_{type}, Pₑₓₚ, eₛ) where:
[symbol] _{T} is a finite set of terminals,
[symbol] _{N} is a finite set of non-terminals of the grammar,
P_{type}: [symbol] _{N}→Type is a function that gives types of semantic values of all productions.
Pₑₓₚ is the interpretation of the productions of the grammar, i.e., Pₑₓₚ: [symbol] Δ_{P}_{_{type}}ₚ and
eₛ is the start production of the grammar, eₛ∈ [symbol] _{N}

### 2.2 Proving Termination For PEGs

Left-recursive PEGs (with direct or mutual left-recursion) lead to non-terminating parsers. In this section we will present a way to establish whether a PEG is well-formed, where well-formedness implies completeness of the grammar.

Let us fix a PEG [symbol] We define the expression set of [symbol] as:

E( [symbol] )={e′|e′ [symbol] c, c∈Pₑₓₚ(A), A∈υ_{N}}

where [symbol] is a (non-strict) subexpression relation on parsing expressions.

The inventors define three groups of properties over parsing expressions:
0″: parsing expression can succeed without consuming any input,
“>0”: parsing expression can succeed after consuming some input,
“⊥”: parsing expression can fail.

We will write e∈P₀ to indicate that the expression e has property “0” (similarly for P_{>0} and P_{⊥}). The inventors have defined inference rules for deriving those properties in Annex C.

Then one start with empty sets of properties and apply those inference rules until reaching a fixpoint. The existence of the fixpoint is ensured by the fact that we extend the property sets monotonously and they are bounded by the finite set E( [symbol] ). We summarize the semantics of those properties in the lemma below:

Lemma 6: The semantics of property sets [symbol] ₀, [symbol] _{>0} and [symbol] _{⊥} is summarized as follows:

if (e, s) [symbol] √ₛ then e∈ [symbol] ₀,

if (e, s) [symbol] √_{s′} and |s′|<|s| then e∈ [symbol] _{>0} and

if (e, s) [symbol] ⊥ then e∈ [symbol] _{⊥}.

Using the semantics of those properties of parsing expression we can perform the well-formedness analysis for G. We introduce a set of well-formed expressions WF and again iterate from an empty set by using derivation rules from Annex D until reaching a fixpoint.

We say that G is well-formed if E(G)=WF. We have the following result:

Theorem 7: If G is well-formed then it is complete.

We conclude this section with an example:

### Example 2

Let us extend the grammar from Example 1 with semantic actions. The grammar expressed mathematical expressions and we attach semantic actions evaluating those expressions, hence obtaining a very simple calculator.

It often happens that we want to ignore the semantic value attached to an expression. This can be accomplished by coercing this value to I, i.e., e[ [symbol] ] λx. I, which we will abbreviate with e[#].

```
    ws ^{::=} ([␣] / [\t] )* [#]
number ^{::=} [0-9] + [ [symbol]   ] digListToNat
  term ^{::=} ws number ws [ [symbol]   ] λ x . x₂
      / ws [(] expr [)] ws [ [symbol]   ] λ x . x₃
factor ^{::=} term [*] factor [ [symbol]   ] λ x . x₁ * x₃
      / term
  expr ^{::=} factor [+] expr [ [symbol]   ] λ x . x₁ + x₃
      / factor
```

This grammar will associate, as expected, the semantic value 36 with the string “(1+2)*(3*4)”. Of course in practice instead of evaluating the expression we would usually write semantic actions to build a parse tree of the expression for later processing.

### 2.3 Interpretation of PEGs

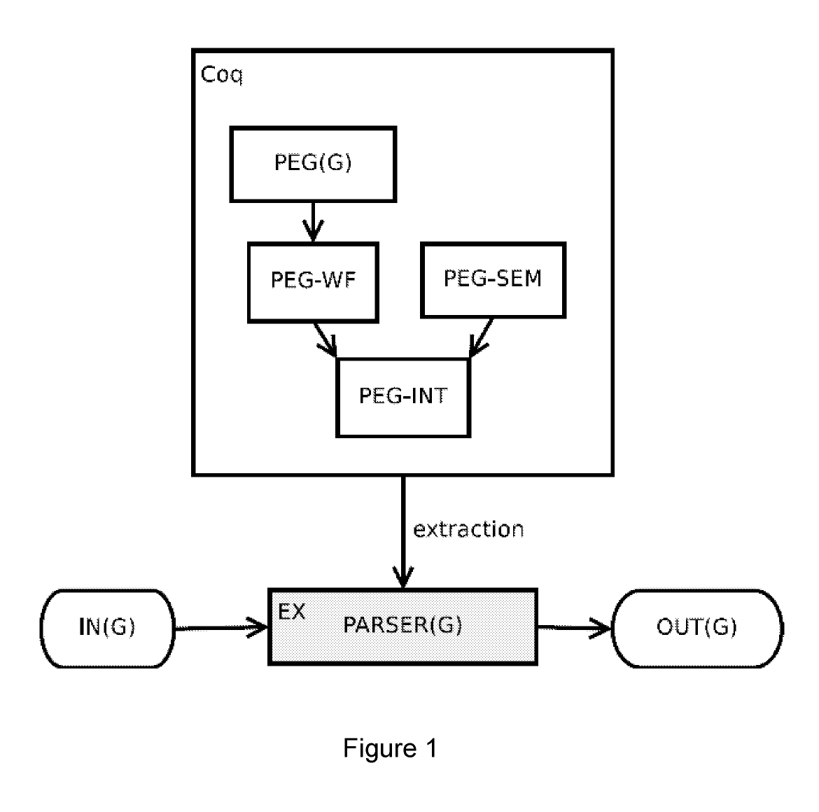

In this section a method and system to obtain a certified parser interpreter using the formalism of PEGs (presented in previous sections) is presented. The schema of our approach is presented in FIG. 1.

One way to obtain such a parser interpreter is to formally develop it in Coq and then extract a certified code from this development. In order to do that first one needs to develop a formalization of PEGs (Sections 5.1 and 5.2.1 along with their semantics PEG-SEM (annex B2), and a procedure for checking their well-formedness PEG-WF (Section 5.2.2, Annex D).

Then one needs to develop a generic interpreter for parsing input with an arbitrary, but well-formed, grammar, PEG-INT. Such an interpreting function along with the proof that it respects the semantics of PEGs can be developed rather easily as it is essentially just a straightforward realization of the semantics presented in annex B2. The only difficulty is the problem of termination which is addressed below.

In the approach of an embodiment of the invention to develop a certified interpreter the inventor assumes that the grammar G in question (Definition 3) is expressed in Coq, PEG(G). That means that all semantic actions e[ [symbol] ]ƒ used in the grammar are terminating, as all Coq functions are total.

That leaves the inventors with proving that the process of parsing itself will terminate but for that the inventors use the (previously proved) fact that the grammar is well-formed and the analysis of Section 5.2.2, in particular Theorem 7.

Having all those components in place we are ready to extract from Coq a PEG interpreter specialized to grammar G. As a result we obtain a source code of the parser for G in one of the languages supported by Coq's extraction mechanism (OCaml, Haskell and Scheme at the time of this writing).

It is important to note that the fact that the parser interpreter of an embodiment of the invention is totally correct is provided by (a) the grammar G is well-formed and (b) all its semantic actions are terminating. These are some key features of an embodiment of the invention.

In the approach of this embodiment of the invention those conditions are verified within Coq before extracting an interpreter for G, so that it's certain that those conditions are satisfied. In principle, a generic parser interpreter for PEGs can also be extracted from the development. Then the grammar G instead of being developed in Coq could be provided from within the language used for extraction. However then, if one of the conditions (a) or (b) is not meet the resulting parser may not be terminating.

The main shortcoming of this approach is that in order to obtain a parser for G one needs to write the PEG for G, including its semantic actions; in Coq (unless we resort to the approach sketched in the preceding paragraph but then we cannot guarantee total correctness). That means that the use of our parser interpreter involves an expertise in Coq, hence making it much less accessible than traditional parser generators. We will show how to overcome this shortcoming in the following section.

We conclude this section with an example:

### Example 3

After defining appropriate notations and coercions, the transcription of Example 6 in Coq could look as follows:

| Definition prod_type (p : prod) : Type := | | | |
|---|---|---|---|
| match p with | | | |
| \| ws => True | | | |
| \| _ => Q | | | |
| end. | | | |
| Definition char2nat (c : char) : nat := | | | |
| nat_of_ascii c - nat_of_ascii ″0″. | | | |
| Program Definition digListToNat (ds : list char) := | | | |
| let digs := List.map char2nat (List.rev ds) in | | | |
| let fix convert digs := | | | |
| match digs with | | | |
| \| nil => 0 | | | |
| \| x: :xs => x + (10 * convert xs) | | | |
| end | | | |
| in | | | |
| convert digs. | | | |
| Program Definition production p := | | | |
| match p return PExp (prod_type p) with | | | |
| \| ws | => | (″ ″ / ″\t″) [*] | [#] |
| \| number | => | [″0″--″9″] [+] | [->] digListToNat |
| \| term | => | ws; number; ws | [->] (fun v => A2 v) |
| | / | ws; ″(″; expr; ″)″; ws | [->] (fun v => A3 v) |
| \| factor | => | term; ″*″; factor | [->] (fun v => A1 v * A3 v) |
| | / | term | |
| \| expr | => | factor; ″+″; expr | [->] (fun v => A1 v + A3 v) |
| | / | factor | |
| end. | | | |

### Example 4

We present an alternative version of the grammar from Example 3, where the semantic actions are used to build an abstract syntax tree (AST) of mathematical expressions, instead of evaluating them.

```
Inductive Expr :=
  | SUM (e1 e2 : Expr)
  | MUL (e1 e2 : Expr)
  | VAL (val : Q).
Definition prod_type (p : prod) : Type :=
  match p with
  | ws => True
  | number => Q
  | _ => Expr
  end.
Program Definition digListToNat (ds : list char) : nat := ...
Program Definition production p :=
match p return PExp (prod_type p) with
```

| | | | |
|---|---|---|---|
| \| ws | => | (″ ″ / ″\t″) [*] | [#] |
| \| number | => | [″0″--″9″] [+] | [->]digListToNat |
| \| term | => | ws; number; ws | [->] (fun v => VAL (A2 v)) |
| | / | ws; ″(″; expr; ″)″; ws | [->] (fun v =>A3 v) |
| \| factor | => | term; ″*″; factor | [->] (fun v => MUL (A1 v) (A3 v)) |
| | / | term | |
| \| expr | => | factor; ″+″; expr | [->] (fun v => SUM (A1 v) (A3 v)) |
| | / | factor | |

end.

### 2.4 Parser Generator For PEGs

In this section a method and system of developing TRX is presented: TRX is a parser generator that on top of the functionality offered by traditional parser generators will provide total correctness guarantees for all generated parsers. That makes it especially suitable for use in all types of critical software, where such strong correctness is called for.

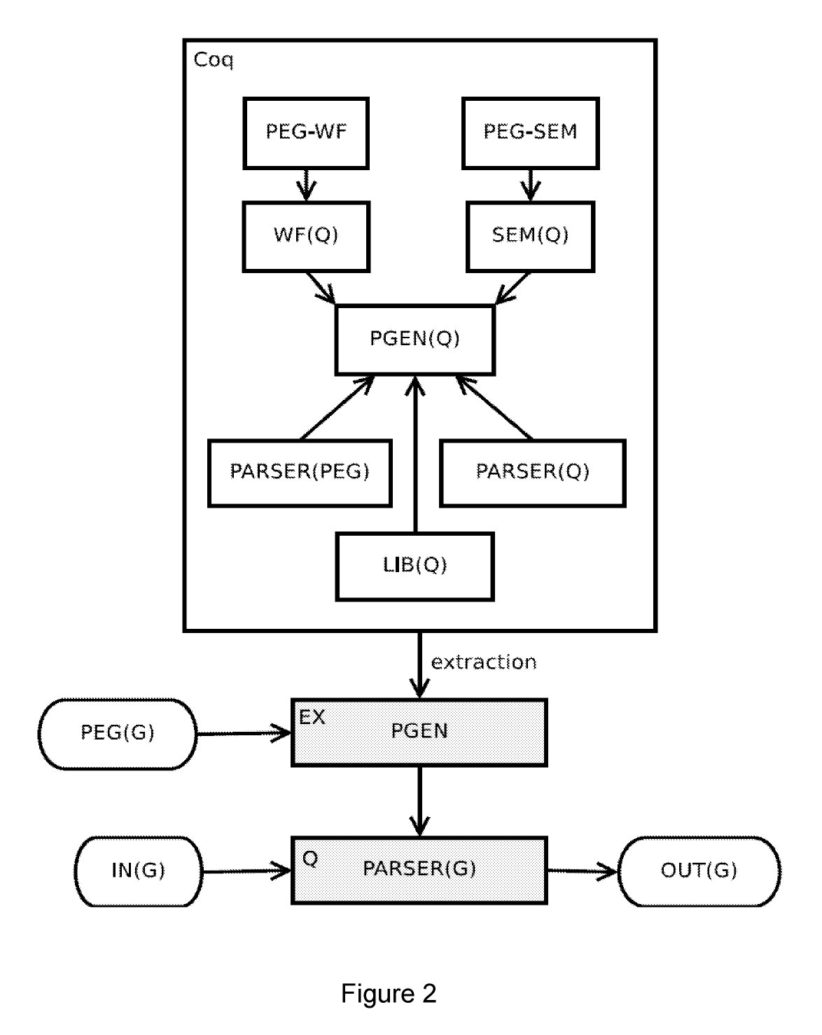

But as the use of this generator gives safety guarantees at no additional effort, it can be a very attractive alternative to traditional parser generators in essentially all applications. The schema of the approach of the inventors is presented in FIG. 2.

The target language of our parser generator is Q. It will be mainly interested in functional programming languages, but most of the ideas presented below can be used for an arbitrary target language Q.

A number of things changes compared with the approach from the previous section (interpreter). To begin with instead of extracting from Coq an interpreter for a particular PEG G, the approach wants to be able to extract a parser generator, PGEN, that will take as its input a description of a grammar G, PEG(G), and will produce a parser for G as a source code in Q, PARSER(G).

In order to achieve that we need a parser for PEGs themselves, PARSER(PEG), as well as a parser for Q, PARSER(Q), as the productions in the grammar will be expressed as a source code in Q. One way to obtain those parsers is by developing certified interpreters for them using the approach described in Section 5.2.3.

The treatment of termination also changes. The grammar G now comes from an external file without any guarantees, so after parsing it with the certified parser PARSER(PEG), it is needed to check its well-formedeness. The inventors do this as before with the component PEG-WF, but now it will not be invoked in Coq but will become part of the extracted code, comprising the parser generator PGEN.

But the real difficulty lies in the fact that to establish termination of produced parsers it's not only needed to know that the grammar is well-formed, but also that all semantic actions used within it are terminating which involves termination analysis of Q programs, WF(Q). In the approach of Section 5.2.3 one got termination of semantic actions for free as they were expressed in Coq (all Coq functions are total).

One way to tackle this problem is to formally develop a termination checker for Q (necessarily incomplete as the termination problem is undecidable for any Turing-complete language).

This is difficult and the inventors opt for an easier approach. They choose a language Q_{fin} which is a subset of Q designed in such a way that all Q_{fin} programs are terminating (which obviously is prove in Coq). For instance for an ML style pure functional programming language one can obtain this restricted language by forbidding recursion (which is the only source of non-termination). Now we only allow semantic actions to be expressed in Q_{fin}.

This is quite a restriction but the role of semantic actions in a grammar is to construct a parse tree of the input, which often involves little more than choosing parts of the parse trace and enclosing it in appropriate algebraic data-types. To somewhat ease this restriction we develop a very simple “standard library for parsing”, LIB(Q), comprising of basic data-types (lists, trees, . . . ) and basic operations on them (map, fold, . . . ), which we prove terminating in Coq. Now we can allow semantic actions written in Q_{fin}, but making use of this library and we still are able to prove termination of generated parsers.

The next step is to write a parser generator in Coq. The process of generating a recursive descent parser for a PEG is relatively straightforward. The basic idea is that the set of productions of G is mapped one-to-one to a mutually recursive set of parse functions in Q. Parsing every PEG operand consists of turning operational semantics rules of Annex B2 into an executable code.

Now we need to prove total correctness for such generated parsers. All the reasoning will be performed with the formal semantic of Q, SEM(Q). This semantics together with the semantics of PEGs, PEG-SEM, will be used to prove that generated parsers are correct. As for their termination, termination analysis of Q, WF(Q), will be used to ensure termination of semantic actions and combined with well-formedness analysis for PEG grammars, PEG-WF.

We will now present a few examples.

### Example 5

In this example we illustrate a possible concent of the library LIB(Q), where Q is again taken to be OCaml. Such a library could consist of the following functions taken from the standard library of OCaml:

```
  Module Pervasives:
val bool_of_string : string -> bool
val int_of_string : string -> int
val float_of_string : string -> float
  Module List:
type ′a list
val length : ′a list -> int
val nth : ′a list -> int -> ′a
val rev : ′a list -> ′a list
val append : ′a list -> ′a list -> ′a list
val map : (′a -> ′b) -> ′a list -> ′b list
val fold_left : (′a -> ′b -> ′a) -> ′a -> ′b list -> ′a
val for_all : (′a -> bool) -> ′a list -> bool
val exists : (′a -> bool) -> ′a list -> bool
val mem : ′a -> ′a list -> bool
val find : (′a -> bool) -> ′a list -> ′a
val filter : (′a -> bool) -> ′a list -> ′a list
val partition : (′a -> bool) -> ′a list -> ′a list * ′a list
```

All of those functions would need to be proven terminating in Coq.

### Example 6

In this example we will present a PEG grammar PEG(G), equivalent to that from Example 2 but rendered as an ASCII file to be processed by the parser generator. We again take OCaml as the target language Q, so semantic actions of the grammar are expressed as pieces of code in OCaml, where recursion is not allowed.

| | | | |
|---|---|---|---|
| ws | : := | (′ ′ / ′\t′)* | # |
| number | : := | [0-9] + | {{ int_of_string _1 }} |
| term | : := | ws number ws | {{ _2 }} |
| | / | ws ′(′ expr ′)′ ws | {{ _3 }} |
| factor | : := | term ′*′ factor | {{ _1 * _3 }} |
| | / | term | |
| expr | : := | factor ′+′ expr | {{ _1 +_3 }} |
| | / | factor | |

We use the {. . . } annotation for semantic actions in place of the PEG operator e[ [symbol] ]f.

### Example 7

We present an alternative version of the grammar from Example 6, where the semantic actions are used to build an abstract syntax tree (AST) of mathematical expressions, instead of evaluating them.

| {{ | | | |
|---|---|---|---|
| type expr = | | | |
| \| MUL of expr * expr | | | |
| \| ADD of expr * expr | | | |
| \| VAL of int | | | |
| }} | | | |
| ws | : := | (′ ′ / ′\t′)* | # |
| number | : := | [0-9] + | {{ int_of_string _1 }} |
| term | : := | ws number ws | {{ VAL _2 }} |
| | / | ws ′(′ expr ′)′ ws | {{ _3 }} |
| factor | : := | term ′*′ factor | {{ MUL ( _1 * _3 ) }} |
| | / | term | |
| expr | : := | factor ′+′ expr | {{ ADD ( _1 + _3 ) }} |
| | / | factor | |

Let's conclude this section with a summary of the differences between TRX and any other (unverified) parser generator from the points of view of: the TRX end user and the TRX developer.

### 2.4.1 TRX From the Point of View of the End User

From the point of view of the user of our formally verified parser generator TRX the process of generating a parser will essentially be indistinguishable from this process with any other such (unverified) tool and will consist of the following steps:
Writing a text file with a PEG grammar G, including its semantic actions as a code in Q.
Running our parser generator to generate a parser for G expressed as a source code in Q.
The parser generator will reject the grammar if it is syntactically incorrect or incorrect with respect to Definition 4 (for instance if it contains references to undefined non-terminals). It will also reject the input if the grammar G is not well-formed, i.e., it is left-recursive. This last check is also performed, though its correctness cannot be guaranteed, by some of the existing parser generators based on the PEG formalism.
The parser generator will also reject the grammar if the semantic actions contain recursion and hence may be potentially non-terminating (we will only allow calls to a predefined library of recursive functions with some basic combinators for basic data-types, to improve expressivity of acceptable semantic actions). This is the only difference with using TRX compared to other unverified parser generators, which typically do not try to ensure termination of the generated code (in fact they often do not even check whether semantic actions are syntactically correct and just copy it verbatim to the generated parser).
If no errors are discovered TRX will produce a parser for G expressed as a source code in Q, pretty much as any other parser generator would do. The difference is that the parser generated by TRX is formally proved to be totally correct, i.e., the parser is terminating and correct with respect to the grammar G and the semantics of PEGs.

### 2.4.2 TRX From the Point of View of Developing A Parser Generator

In contrast to the previous section, developing TRX involves substantially more effort, compared to an un-certified parser generator. The steps leading to generating a certified parser are as follows:
Reading and parsing a text file with a PEG G including semantic actions expressed in Q. The difference here is that TRX will use certified parsers for parsing PEGs and the code in Q.
Checking that the grammar G is well-formed. This check is often performed by other PEG-based parser generators but in case of TRX this procedure will be formally proved correct in Coq.
Checking that the semantic actions are terminating, by disallowing recursive calls. Calls to a predefined library of (recursive) functions are allowed. This step is completely missing in typical parser generators. It is necessary in TRX to ensure termination of the generated parser and hence its total correctness. This step will be formally proved correct in Coq.
After ensuring that the grammar is correct it is transformed to a recursive descent parser in Q. In TRX this step will be accompanied by a proof that this transformation produces a terminating parser, which is correct with respect to the grammar G and the semantics of PEGs (Annex B2).
Finally, TRX will be developed using dependent type programming in the proof assistant Coq and then the executable TRX will be extracted from this development using Coq's extraction mechanism.

### 3. Summary of Three Embodiments of the Invention

In this section we shortly summarize the three embodiments of this invention. The following notions are used:
PA: a proof assistant used to develop a formally verified parser interpreter/generator. Examples include: Coq, HOL4, HOL Lite, Isabelle, PVS, . . . .
FPG: a formalism for expressing grammars used by the parser interpreter/generator. Examples include: context-free grammars (CFGs) and parsing expression grammars (PEGS).
Q: the target language of the parser generator.
G: the grammar in FPG format which we want to interpret (parser interpreter) or for which we want to generate a parser as a source code in Q (parser generator).

All the three embodiments use the approach of specifying and developing a parser interpreter/generator in the PA and then extracting a parser interpreter/generator with total correctness guarantees using the extraction mechanism of the PA, hence the parser interpreter/generator is obtained as a source code in a language supported by the extraction capabilities of the PA.

### 3.1 First Embodiment: Parser Interpreter With Semantic Actions

This embodiment describes a way to obtain a formally verified parser interpreter, with the following properties:
Semantic actions are used to specify a parsing result.
The grammar and its semantic actions need to be specified in the specification language of the PA.

This embodiment consists in:
1. Defining FPG and its formal semantics.
2. Developing a procedure for checking that a given grammar G belongs to a certain class of grammars for which parsing is feasible.
3. Developing a parser interpreter, that will take a grammar G with semantic actions, both specified in the PA, and, after checking that G belongs to a class for which parsing is feasible (A2), it will interpret the grammar generating a parse tree, by invoking semantic actions embedded in G.
4. Proving that the parser interpreter (A3) is correct with respect to the semantics of FPG (A1) and the grammar G with its semantic actions.
5. Proving that the parser interpreter (A3) will always terminate. This reasoning will use some properties of G (A2), which ensure termination of its parsing.
6. Extracting a certified parser interpreter based on the development (A3). The interpreter is totally correct due to (A4) and (A5).

### 3.2 Second Embodiment: Parser Generator With Semantic Actions

This embodiment described a way to obtain a formally verified parser generator, with the following properties:
The target language of the generator is any language Q.
Semantic actions (in Q) are used to specify a parsing result.
The grammar and its semantic actions can be specified in a simple text file.

This embodiment consists of:
1. Defining FPG and its semantics.
2. Developing a procedure for checking that a given grammar G belongs to a certain class of grammars for which a translation to a correct, terminating parser is feasible.
3. Defining Q and its formal semantics.
4. Developing a library of basic datatypes of Q and functions over them and proving that they are all terminating.
5. Developing a formally correct parser for Q (B3) (bootstrapping).¹
6. Developing a formally correct parser for a grammar in FPG format (B1).² The grammar will include semantic actions in Q, which will be parsed with (B5).
7. Developing a termination checker for semantic actions in Q (B3).³
8. Developing a parser generator, that will read a description of some grammar G from a text file using the certified parser (B6) and, after checking that the grammar belongs to a class for which parser generation is feasible (B2), it will generate a code of the parser in Q.
9. Proving that the code generated in (B8) is correct with respect to the given grammar G, the semantics of parsing grammars (B1) and the formal semantics of Q (B3).
10. Proving that the code generated in (B8) will always terminate. This reasoning will use the termination checker for semantic actions (B7) and some properties of the grammar G (B2), which ensure termination of its parser.
11. Extracting a certified parser generator based on the development (B8). Every parser generated with this parser generator is totally correct due to (B9) and (B 10).

### 3.3 Third Embodiment: Parser Interpreter With Parsing Traces

This embodiment described a way to obtain a formally verified parser interpreter, with the following properties:
Parsing tags, a simple extension to the parsing grammar formalism, are used to annotate the parts of the grammar that should be collected during parsing to form a parse trace (i.e., a simple parse tree in a predefined XML-like format).
The grammar and its parsing tags can be specified in a simple text file.

This embodiment consists of:
1. Defining FPG extended with parsing tags indicating the information that should be collected in the parsing trace. Defining formal semantics for such extended FPGs.
2. Developing a procedure for checking that a given grammar G belongs to a certain class of grammars for which parsing is feasible.
3. Developing a formally correct parser for a grammar in FPG format (C1).⁴ The grammar will include tags that indicate information (and its structure) that should be pertained in the parse tree.
4. Developing a parser interpreter, that will read a description of some grammar G from a text file using the certified parser (C3) and, after checking that the grammar belongs to a class for which parsing is feasible (C2), it will interpret the grammar generating a parse tree, according to the parse tags embedded in the grammar (C1).
5. Proving that the parser interpreter (C4) is correct with respect to the given grammar G (with its parsing tags) and the semantics of parsing grammars (C1) (including the semantics of parsing tags).
6. Proving that the parser interpreter (C4) will always terminate. This reasoning will use some properties of the grammar G (C2), which ensure termination of its parsing.
7. Extracting a certified parser interpreter based on the development (C4). The interpreter is totally correct due to (C5) and (C6).

An exemplary aspect of the disclosure therefore provides a parser generator that is capable of performing both the lexical analysis and the syntax analysis in an uniform way and that additionally will be correct by construction, i.e., the generated parser will come with total correctness guarantees, as if the generated parser was subject to formal verification using a theorem proving technology.

An exemplary aspect of the disclosure makes this process completely transparent to the end-user of the parser generator. That means that from the point of view of the user, the process of generation of a parser is equivalent to that sketched in the preceding section. In particular the parser generator will be a single executable, functionally equivalent to the traditional parser generator and no use of a theorem prover will be involved at all; and yet the generated parser will be provably correct by construction, allowing its use in critical systems, requiring strong correctness guarantees.

3. The following annexes are fully included in the specifications.

### 3.1 ANNEX A: Formal Semantics of PEGS

$$\overline{( ε , s ) {√}_{s}}$$

$$\frac{( {P}_{exp} ( p ) , s ) r}{( p , s ) r}$$

$$\overline{( [ \cdot ] , x ∷ xs ) {√}_{xs}}$$

$$\overline{( [ \cdot ] , [ ] ) ⊥}$$

$$\overline{( x , x ∷ xs ) {√}_{xs}}$$

$$\overline{( x , [ ] ) ⊥}$$

$$\frac{x \neq y}{( y , x ∷ xs ) ⊥}$$

$$\frac{( {e}_{1} , s ) ⊥}{( {e}_{1} ; {e}_{2} , s ) ⊥}$$

$$\frac{( {e}_{1} , s ) {√}_{{s}^{′}} ( {e}_{2} , {s}^{′} ) r}{( {e}_{1} ; {e}_{2} s ) r}$$

$$\frac{( {e}_{1} , s ) {√}_{{s}^{′}}}{( {e}_{1} ; {e}_{2} , s ) {√}_{{s}^{′}}}$$

$$\frac{( {e}_{1} , s ) ⊥ ( {e}_{2} , s ) r}{( {e}_{1} / {e}_{2} , s ) r}$$

$$\frac{( e , s ) {√}_{{s}^{′}} ( {e}^{*} , {s}^{′} ) {√}_{{s}^{″}}}{( {e}^{*} , {s}^{′} ) {√}_{{s}^{″}}}$$

$$\frac{( e , s ) ⊥}{( {e}^{*} , s ) {√}_{s}}$$

$$\frac{( e , s ) ⊥}{( ! e , s ) {√}_{s}}$$

$$\frac{( e , s ) {√}_{{s}^{′}}}{( ! e , s ) ⊥}$$

### 3.2.1 ANNEX B: Parsing Expressions Extended To Incorporate Semantic Actions

$$\overline{ε ∈ {Δ}_{True}}$$

$$\overline{[ \cdot ] ∈ {Δ}_{char }}$$

$$\frac{a ∈ {V}_{T}}{a ∈ {Δ}_{char }}$$

$$\frac{A ∈ {V}_{N}}{A ∈ Δ {P}_{type ( A )}}$$

$$\frac{{e}_{1} ∈ {Δ}_{α} {e}_{2} ∈ {Δ}_{β}}{{e}_{1} ; {e}_{2} ∈ {Δ}_{α * β}}$$

$$\frac{{e}_{1} ∈ {Δ}_{α} {e}_{2} ∈ {Δ}_{α}}{{e}_{1} / {e}_{2} ∈ {Δ}_{α}}$$

$$\frac{e ∈ {Δ}_{α}}{{e}^{*} ∈ {Δ}_{list α}}$$

$$\frac{e ∈ {Δ}_{α}}{! e ∈ {Δ}_{True}}$$

$$\frac{e ∈ {Δ}_{α} f : α \to β}{e [ ↦ ] f ∈ {Δ}_{β}}$$

Parsing expressions extended to incorporate semantic actions.

### 3.2.2 ANNEX B2: Formal Semantics of PEGs With Semantic Actions

$$\overline{( ε , s ) {√}_{s}^{I}}$$

$$\frac{( {P}_{exp} ( p ) , s ) r}{( p , s ) r}$$

$$\overline{( [ \cdot ] , x ∷ xs ) {√}_{xs}^{x}}$$

$$\overline{( [ \cdot ] , [ ] ) ⊥}$$

$$\overline{( x , x ∷ xs ) {√}_{xs}^{x}}$$

$$\overline{( x , [ ] ) ⊥}$$

$$\frac{x \neq y}{( y , x ∷ xs ) ⊥}$$

$$\frac{( {e}_{1} , s ) ⊥}{( {e}_{1} : {e}_{2} , s ) ⊥}$$

$$\frac{( {e}_{1} , s ) {√}_{{s}^{′}}^{{v}_{1}} ( {e}_{2} , {s}^{′} ) ⊥}{( {e}_{1} ; {e}_{2} , s ) ⊥}$$

$$\frac{( {e}_{1} , s ) {√}_{{s}^{′}}^{{v}_{1}} ( {e}_{2} \cdot {s}^{′} ) {√}_{{s}^{″}}^{{v}_{2}}}{( {e}_{1} ; {e}_{2} \cdot s ) {√}_{{s}^{″}}^{( {v}_{1} , {v}_{2} )}}$$

$$\frac{( {e}_{1} \cdot s ) {√}_{{s}^{′}}^{v}}{( {e}_{1} / {e}_{2} , s ) {√}_{{s}^{′}}^{v}}$$

$$\frac{( {e}_{1} , s ) ⊥ ( {e}_{2} , s ) r}{( {e}_{1} / {e}_{2} , s ) r}$$

$$\frac{( e , s ) {√}_{{s}^{′}}^{v} ( {e}^{*} , {s}^{′} ) {√}_{{s}^{″}}^{vs}}{( {e}^{*} , s ) {√}_{{s}^{″}}^{v ∷ vs}}$$

$$\frac{( e , s ) ⊥}{( {e}^{*} , s ) {√}_{s}^{[ ]}}$$

$$\frac{( e , s ) ⊥}{( ! e , s ) {√}_{s}^{I}}$$

$$\frac{( e , s ) {√}_{{s}^{′}}^{v}}{( ! e , s ) ⊥}$$

$$\frac{( e , s ) ⊥}{( e [ ↦ ] f , s ) ⊥}$$

$$\frac{( e , s ) {√}_{{s}^{′}}^{v}}{( e [ ↦ ] f , s ) {√}_{{s}^{′}}^{f ( v )}}$$

### 3.3 ANNEX C: Deriving Grammar Properties

$$\overline{ε ∈ {ℙ}_{0}}$$

$$\overline{[ \cdot ] ∈ {ℙ}_{> 0}}$$

$$\overline{[ \cdot ] ∈ {ℙ}_{⊥}}$$

$$\frac{a ∈ {V}_{T}}{a ∈ {ℙ}_{> 0}}$$

$$\frac{a ∈ {V}_{T}}{a ∈ {ℙ}_{⊥}}$$

$$\frac{e ∈ {ℙ}_{⊥}}{{e}^{*} ∈ {ℙ}_{0}}$$

$$\frac{e ∈ {ℙ}_{> 0}}{{e}^{*} ∈ {ℙ}_{> 0}}$$

$$\frac{e ∈ {ℙ}_{⊥}}{! e ∈ {ℙ}_{0}}$$

$$\frac{e ∈ {ℙ}_{\geq 0}}{! e ∈ {ℙ}_{⊥}}$$

$$\frac{★ ∈ \{ 0 , > 0 , ⊥ \} A ∈ {V}_{N} {P}_{exp} ( A ) ∈ {ℙ}_{★}}{ A ∈ {ℙ}_{★}}$$

$$\frac{{e}_{1} ∈ {ℙ}_{⊥} ( {e}_{1} ∈ {ℙ}_{\geq 0} {e}_{2} ∈ {ℙ}_{⊥} )}{{e}_{1} ; {e}_{2} ∈ {ℙ}_{⊥}}$$

$$\frac{{e}_{1} ∈ {ℙ}_{0} {e}_{2} ∈ {ℙ}_{0}}{{e}_{1} ; {e}_{2} ∈ {ℙ}_{0}}$$

$$\frac{( {e}_{1} ∈ {ℙ}_{> 0} {e}_{2} ∈ {ℙ}_{\geq 0} ) ( {e}_{1} ∈ {ℙ}_{\geq 0} {e}_{2} ∈ {ℙ}_{> 0} )}{{e}_{1} ; {e}_{2} ∈ {ℙ}_{> 0}}$$

$$\frac{{e}_{1} ∈ {ℙ}_{0} ( {e}_{1} ∈ {ℙ}_{⊥} {e}_{2} ∈ {ℙ}_{0} )}{{e}_{1} / {e}_{2} ∈ {ℙ}_{0}}$$

$$\frac{{e}_{1} ∈ {ℙ}_{⊥} , {e}_{2} ∈ {ℙ}_{⊥}}{{e}_{1} / {e}_{2} ∈ {ℙ}_{⊥}}$$

$$\frac{{e}_{1} ∈ {ℙ}_{> 0} ( {e}_{1} ∈ {ℙ}_{⊥} {e}_{2} ∈ {ℙ}_{> 0} )}{{e}_{1} / {e}_{2} ∈ {ℙ}_{> 0}}$$

### 3.4 ANNEX D: Deriving Well-Formedness Property For A PEG

$$\overline{ε ∈ WF}$$

$$\overline{[ \cdot ] ∈ WF}$$

$$\frac{a ∈ {V}_{T}}{a ∈ WF}$$

$$\frac{A ∈ {V}_{N} {P}_{exp} ( A ) ∈ WF}{A ∈ WF}$$

$$\frac{{e}_{1} ∈ WF {e}_{1} ∈ {ℙ}_{0} ⇒ {e}_{2} ∈ WF}{{e}_{1} ; {e}_{2} ∈ WF}$$

$$\frac{{e}_{1} ∈ WF {e}_{2} ∈ WF}{{e}_{1} / {e}_{2} ∈ WF}$$

$$\frac{e ∈ WF , e ∉ {ℙ}_{0}}{{e}^{*} ∈ WF}$$

$$\frac{e ∈ WF}{! e ∈ WF}$$

1. A system for building a parser generator, wherein the method comprises:
a grammar input module configured to input in said parser generator a grammar expressed in a given formalism;
a formalism module configured to express grammars used by said parser generator, said formalism module proving that said grammar G is well-formed;
a semantic action module configured to define a parsing result depending on at least some expression of said grammar, said semantic action module ensuring that all semantic actions of said grammar are terminating semantic actions;
a checking module configured to check that said grammar belongs to a predetermined class of grammars for which a translation to a correct and terminating parser is feasible; and
a proof assistant module configured to develop, if said checking module concludes that said grammar belongs to said predetermined class of grammar: said parser generator with said formalism and said semantic action module and produce mechanically-verifiable formal proofs of properties of said parser, including but not limited to total correctness properties.

2. The system for building a parser generator of claim 1, wherein said a formalism module forbids recursion in said grammar.

3. The system for building a parser generator of claim 1, wherein said grammar is a context-free grammar;

4. The system for building a parser generator of claim 1, wherein said grammar is a parsing expression grammar;

5. A method for building a formally verified parser generator, wherein the method comprises:
formalizing an expression of a grammar G and its semantics;
checking that said grammar G belongs to a predetermined class of grammars for which a translation to a correct, terminating parser is feasible;
defining a target language Q of said parser generator and its formal semantics;
obtaining a library of basic data types of Q and functions over them and proving that they are all terminating;
obtaining a formally correct parser for Q;
obtaining a formally correct parser for a grammar in FPG format, said including semantic actions in Q;
obtaining a termination checker for semantic actions in Q;
obtaining a parser generator, that will read a description of some grammar G from a text file using said certified parser and, after checking that the grammar belongs to a class for which parser generation is feasible, it will generate a code of the parser in Q;
obtaining, from a proving module, that the code generated in is correct with respect to the given grammar G, the semantics of parsing grammars and the formal semantics of Q; and
obtaining, from a proving module, that the code generated in will always terminate.

6. A non-transitory computer-readable medium comprising a computer program product wherein the program product comprises program code instructions for execution of a method of building a parser when the program is executed on a processor, wherein the method comprises:
formalizing an expression of a grammar G and its semantics;
checking that said grammar G belongs to a predetermined class of grammars for which a translation to a correct, terminating parser is feasible;
defining a target language Q of said parser generator and its formal semantics;
obtaining a library of basic data types of Q and functions over them and proving that they are all terminating;
obtaining a formally correct parser for Q;
obtaining a formally correct parser for a grammar in FPG format, said including semantic actions in Q;
obtaining a termination checker for semantic actions in Q;
obtaining a parser generator, that will read a description of some grammar G from a text file using said certified parser and, after checking that the grammar belongs to a class for which parser generation is feasible, it will generate a code of the parser in Q;
obtaining, from a proving module, that the code generated in is correct with respect to the given grammar G, the semantics of parsing grammars and the formal semantics of Q; and
obtaining, from a proving module, that the code generated in will always terminate.
